(19) United States
(12) Patent Application Publication
(10) Pub. No.: US 2007/0052242 A1
(43) Pub. Date: Mar. 8, 2007

(54) Energy recovery system and method

(76) Inventor: John Mascarin, Acton (CA)

Correspondence Address: John Mascarin, 44 Birchway Place, Acton, ON, L7J 2X7, CA

(21) Appl. No.: 11/515,902

(22) Filed: Sep. 6, 2006

Related U.S. Application Data
(60) Provisional application No. 60/713,749, filed on Sep. 6, 2005.

(51) Int. Cl. H02K 7/18; F03G 7/08; F02B 63/04

(52) U.S. Cl. 290/1 R

(57) ABSTRACT

A system and method for recovering energy consisting of a mechanical apparatus having a principal motor and a drive shaft, and a recovery motor having a drive means coupled to the drive shaft of the principal motor, wherein the rotation of the drive means is a function of the rotation of the drive shaft, and wherein the recovery motor is adapted to generate electric energy from the rotational movement of the drive means. The system includes an inverter means for receiving and converting the direct current electric energy from the recovery motor to alternating current electric energy using a rectifier means. The system further includes a switch means for receiving and providing the recovered electric energy to the commercial power source, one or more secondary apparatuses or a combination thereof.

### RELATED APPLICATIONS

This application claims priority under 35 U.S.C. § 119(e) to U.S. Provisional Patent Application No. 60/713,749 which was filed on Sep. 6, 2005 and which is incorporated herein by reference.

### FIELD OF THE INVENTION

The present invention relates to an energy recovery system and method for generating electric energy, and more particularly to an energy recovery system and method for recovering and generating electric energy from mechanical apparatuses in residential, commercial and industrial facilities.

### BACKGROUND OF THE INVENTION

The increasing demand for electrical energy resources has placed considerable pressure on utility companies throughout the world. Utility companies are frequently considering new and efficient forms of energy generation techniques to replace or supplement traditional power generation stations and to minimize the environmental impact of burning natural resources resulting in air pollution and contributing to global warming.

In order to encourage the development of new forms of energy generation, utility companies are offering “net-metering” or cost reductions to individuals and businesses that have their own renewable energy generator(s), such as a wind turbines or solar panels. Under net metering, excess electrical power produced through the use of wind turbines, for example, would be fed into the commercial power grid. The generation and feeding of electrical energy into the commercial power grid would effectively reverse the utility meter and bank the electrical power until it is needed by the customer. Wind turbines and solar panels are unreliable sources of energy given that both methods rely on natural phenomenon. Moreover, the prohibitive costs associated with installing these energy recovery systems has been a primary factor limiting the general use of such applications in residential and commercial applications.

Consequently, there is a need for an energy recovery system to generate a stable and environmentally safe source of electrical energy to supplement increasing household, commercial and industrial electrical energy demand. There is a further need for an after-market energy recovery system having a recovery motor which can be easily installed on the principal motor(s) of existing apparatuses, machines and other devices. The recovery system can also be incorporated at time of manufacture of the apparatus, machine or device, thereby enabling the manufacturer to market the same as an energy efficient product.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a schematic diagram of an energy recovery system for generating electric energy in a building facility in accordance with an embodiment of the present invention;

FIG. 2 is a schematic diagram of an energy recovery system for generating and providing electric energy in a building facility to one or more secondary apparatuses and the commercial power source in accordance with an embodiment of the present invention;

FIG. 3 is an enlarged, partly broken away, side elevation view of the principal motor of a ventilation mechanical apparatus coupled to the recovery motor in accordance with an embodiment of the present invention shown in FIG. 1;

FIG. 4 is an enlarged, sectional view of recovery motor and drive means shown in FIG. 3 in accordance with an embodiment of the present invention;

FIG. 5 illustrates the steps in an energy recovery method in accordance with an embodiment of the present invention;

FIG. 6 is a diagrammatic view of a plurality of recovery motors generating and providing electric energy from principal motors at residential, commercial and industrial building facilities to the commercial power source in accordance with an embodiment of the present invention; and

FIG. 7 is a diagrammatic view of a plurality of recover motors generating and providing electric energy from principals motors in a residential neighbourhood in accordance with an embodiment of the present invention.

### SUMMARY OF THE INVENTION

The subject invention is directed to a system for recovering energy from a mechanical apparatus, the system consisting of a principal motor associated with the mechanical apparatus and having principal motor having a drive shaft for rotatably driving the mechanical apparatus. The system further consisting of a recovery motor having a drive means coupled to the drive shaft of the principal motor, wherein the rotation of the drive means is a function of the rotation of the drive shaft, and wherein the recovery motor is adapted to generate electric energy from the rotational movement of the drive means. The electric energy generated and recovered by the recovery motor is direct current electric energy. An inverter means having an inverter input for receiving and converting electric energy from the one or more recovery motors into a usable current.

The system for recovering electric energy may include a switch means adapted for receiving and providing the alternating current electric energy to commercial power source in a first position and to one or more secondary apparatuses in a second position. The switch means may also be adapted for receiving and providing the alternating current electric energy to the secondary apparatus and the commercial energy source in a third position.

The system for recovering electric energy may also include a gauge means for determining when the additional electric energy consumed to rotatably drive the drive shaft of the principal motor exceeds the electric energy generated by the recovery motor from the rotational movement of the drive means. Preferably, the additional electric energy required to rotatably drive the drive shaft of the principal motor when coupled to the drive means of the recovery motor is less than or equal to the electric energy generated by the recovery motor from the rotational movement of the drive means. The gauge means is adapted to deactivate the principal motor when the additional electric energy consumed to rotatably drive the drive shaft of the principal motor exceeds the electric energy generated by the recover motor from the rotational movement of the drive means.

The recovery motor of the system for recovering energy from one or more mechanical apparatuses may be any suitable motor, including, but not limited to a multi-phase, brushless direct current motor and a single-phase, brushless direct current motor. The horsepower of the recovery motor is less than the horsepower of the principal motor.

The subject invention is also directed to a method of recovering energy from one or more mechanical apparatuses, each having a principal motor and a drive shaft, that consists of the steps of (a) providing at least one recovery motor having a drive means, (b) coupling the drive means of the recovery motor to the drive shaft of the principal motor, (c) actuating the principal motor to rotatably drive the drive shaft and operate the mechanical apparatus, wherein the drive shaft rotatably drives the drive means of the recovery motor, and wherein the rotation of the drive means is a function of the rotation of the drive shaft, and (d) utilizing the recovery motor to generate electric energy from the rotational movement of the drive means.

The method of recovering energy may include the further step of providing the electric energy generated at step (d) to a commercial power source. Furthermore, the method may include the step of utilizing the electric energy generated at step(d) to actuate and operate a secondary apparatus. In accordance with the method of the present invention, the recovery motor continues to generate electric energy until such time as the principal motor ceases to rotatably drive the drive shaft and operate the mechanical apparatus.

The step of utilizing the recovery motor to generate electric energy may include the additional sub-steps of generating and recovering electric energy from the rotational movement of the drive means using the recovery motor, and converting the recovered electric energy from direct current to alternating current electric energy.

The step of utilizing the recovery motor to generate electric energy may also include the sub-steps of generating and recovering electric energy from the rotational movement of the drive means associated with the at least one recovery motor, aggregating the recovered electric energy from the at least one recovery motor, and converting the recovered electric energy from direct current to alternating current electric energy.

The subject invention is further directed to a method for recovering energy from one or more facilities having a mechanical apparatus consisting of a principal motor and a drive shaft. The method consisting of the steps of providing at least one recovery motor having a drive means at each of the one or more facilities, coupling the drive means of the recovery motor to the drive shaft of the principal motor of the mechanical apparatus, actuating the principal motor using a commercial power source to rotatably drive the drive shaft and operate the mechanical apparatus, wherein the drive shaft rotatably drives the drive means of the recovery motor, and wherein the rotation of the drive means is a function of the rotation of the drive shaft, utilizing the recovery motor to generate electric energy from the rotational movement of the drive means resulting from the operation of the mechanical apparatus, and aggregating and providing the electric energy generated by the recovery motors at each of the one or more facilities to the commercial power source.

The method of utilizing the recovery motor to generate electric energy from the rotational movement of the drive means may include the additional sub-step of converting the recovered electric energy from direct current to alternating current electric energy.

### DESCRIPTION OF THE INVENTION

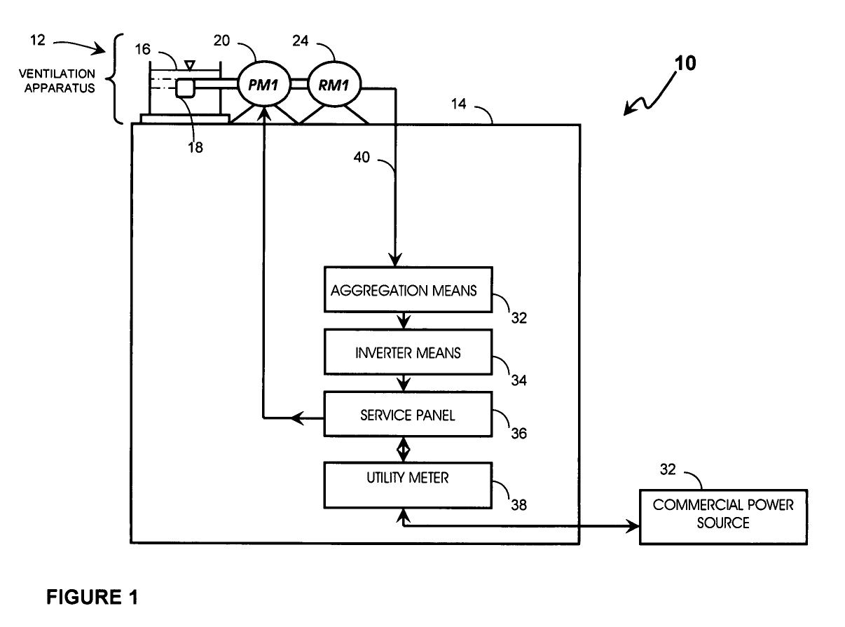

Reference is made to FIGS. 1-4, 6 and 7 which illustrates an energy recovery system 10 made in accordance with a preferred embodiment of the present invention. Energy recovery system 10 is used to recover or capture the electric energy resulting from the operation of one or more mechanical apparatuses 12 at a residential, commercial or industrial facility 14. The energy recovery systems 10 described below with reference to FIGS. 1-5 can be fabricated from any existing components, such as direct current motors, inverter means and the like, and as such, the description does not provide detailed explanation of each component as these will be readily understood by those in the energy recovery and generation arts. Instead, the arrangement of the components relative to each other to create a system for recovering energy from the rotational movement of the principal motor by a recovery motor are discussed with reference to the accompanying figures that show various embodiments and implementations of the energy recovery system 10 of the present invention. Moreover, the various embodiments of the system for recovering electric energy from the operation of a mechanical apparatus 12 and providing the recovered energy to the commercial power source 22 are discussed at length with reference to figures that show several embodiments of energy recovery systems and implementations of energy recovery systems.

Referring to FIGS. 1, 3 and 4, the recovery system 10 is provided adjacent to mechanical apparatus 12 at a facility 14 in accordance with a first embodiment of the present invention. The mechanical apparatus 12 shown in FIG. 1 is an air conditioning apparatus having a cooling tower 16, a water pump 18 having pump blades 19 for pumping water to and from the cooling tower 16, and a principal motor 20 for driving the water pump 18 using electric energy supplied from a commercial power source 22. The recovery system 10 comprises the principal motor 20 and a recovery motor 24 associated with principal motor 20. The principal motor 20 has a drive shaft 26 for rotatably driving and operating the mechanical apparatus 12. The recovery motor 24 has a drive means 28 which is mechanically or electromagnetically coupled to the drive shaft 26 of the principal motor 20 at a connector 30, whereby the rotation of the drive means 28 is a function of the rotation of the drive shaft 26. Recovery motor 24 is adapted to recover and generate electric energy directly from the rotational movement of the drive means 28.

It should be understood that the recovery motor 24 may be any suitable motor as is known by a person skilled in the art, such as, for example, any single or multi-phase motor. In a preferred embodiment, the recovery motor 24 is an efficient, brushless direct current motor which having a lower horsepower than the associated principal motor 20 to which it is coupled.

Referring to FIG. 1, the recovery system 10 further comprises an aggregation means 32, an inverter means 34, a service panel 36 and a utility meter 38 for collecting and monitoring the recovered energy from the recovery motors 24. The aggregation means 32 is adapted to receive and combine the electric energy generated by the recovery motor 24 via a suitable cable 40. The electric energy from the aggregation means 32 is fed to the inverter means 34 which is adapted to receive and convert the electric energy into a useable current, such as, for example, from direct current to alternating current electric energy or vice versa, using a rectifier or similar means, depending upon the intended use of the recovered electric energy and the characteristics of the recovery motor 24. The converted electric energy may then be fed through a service panel 36 which connects the mechanical apparatuses 12 of facility 14 to the commercial power source 22 via a utility meter 38. The utility meter 38 monitors the flow of electric energy to and from the facility 14 and the commercial power source 22. The recovered electric energy generated by the recovery motor 24 from the operation of the mechanical apparatus 12 is then fed back to the commercial power source 22 for consumption by third parties.

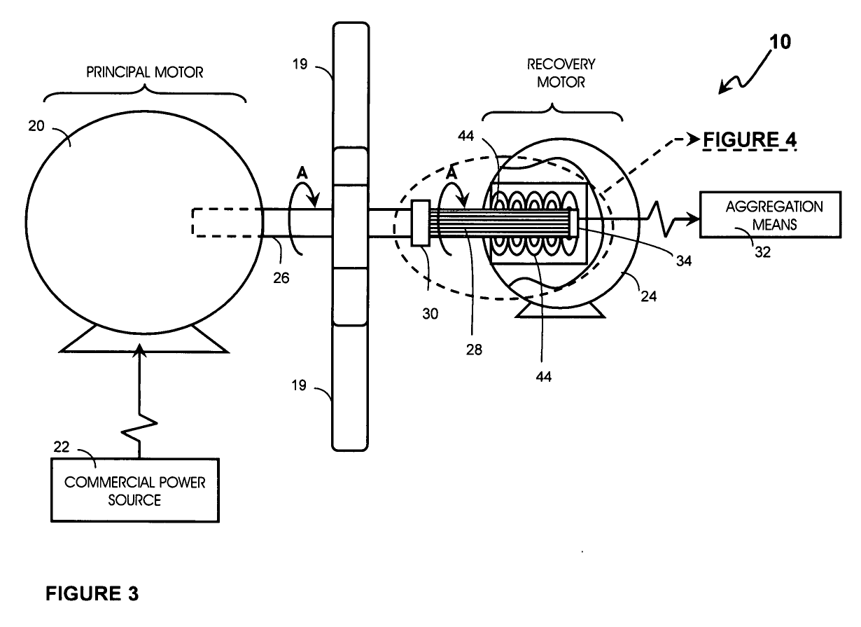

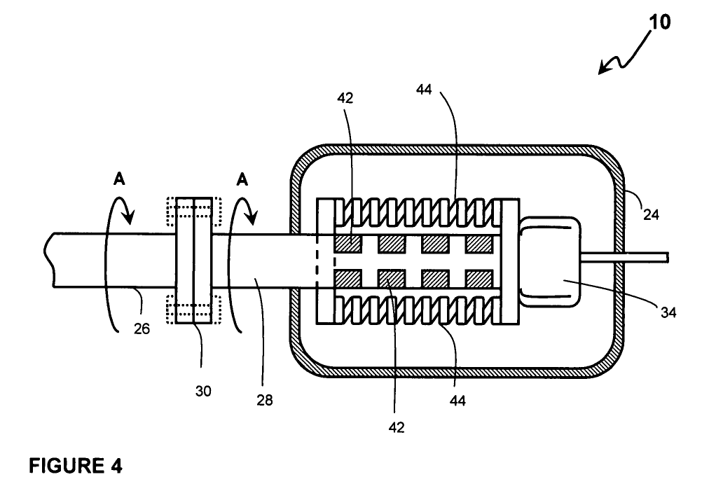

Referring to FIGS. 3 and 4, the circumferential edge of the drive means 28 of the recovery motor 24 may be provided with two or more permanent magnets 42 so as to enable the recovery motor 24 to generate electric energy from the rotational movement of the drive means 28. The permanent magnets 42 are preferably magnetized perpendicularly to the surface of the drive means 28, however, it should be understood that various configurations of permanent magnets 42 may be used in association with the energy recovery system 10 of the present invention. Each of the recovery motors 24 may be provided with a stator/poles 44 and coil windings 46 positioned adjacent to and in magnetic communication with the magnets 42 on the drive means 28. In order to maximize the efficient recovery of electric energy, the air space between the permanent magnets 42 on the drive means 28 and the stator/poles 44 should be limited.

As shown in FIG. 4, the stator/poles 44 are operatively connected to a power generator 48 which generates the electric energy from the rotational movement of the drive means 28 of recovery motor 24. During the operation of the mechanical apparatus 12, and particularly the principal motor 20 and the drive shaft 26, the rotational movement of the drive means 28 adjacent to the stator/poles 44 creates a magnetic field within the recovery motor 24. The electrical energy resulting from the magnetic field flows through the coil windings 46 to the power generator 48. The recovered electrical energy generated by the power generator 34 from the operation of the one or more mechanical apparatuses 12 may then be used power one or secondary apparatuses 50 within the facility 14 or to supply the electric energy to the commercial power source 22 for consumption by third parties.

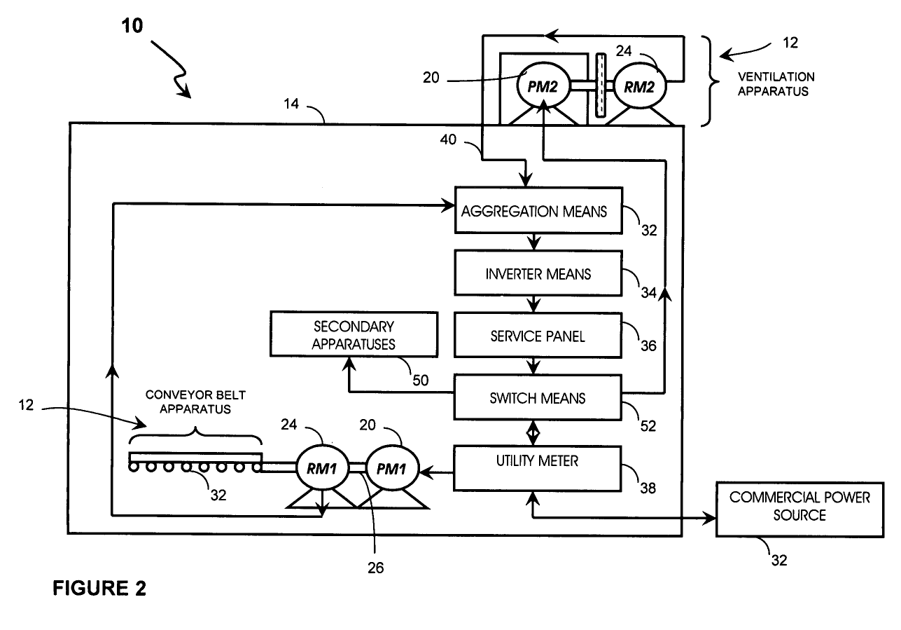

In a second embodiment of the present invention shown in FIG. 2, the recovery system 10 may be adapted to recover electric energy from more than one mechanical apparatuses 12 provided within the facility 14. Commonly, the owners of large scale commercial and industrial facilities must utilize a wide variety of mechanical apparatuses 12, such as, for example, printing presses, stamp presses and conveyor belt apparatuses, to complete its day-to-day operations. In the example of the second embodiment shown in FIG. 2, the mechanical apparatuses 12 provided with the facility 14 include a conveyor belt apparatus and a roof-top ventilation apparatus. Each of the conveyor belt and ventilation apparatuses of the recovery system 10 are provided with a principal motor 20 (shown as reference numerals PM1 and PM2, respectively) and a recovery motor 24 (shown as reference numerals RM1 and RM2). The principal motors 20 (PM1 and PM2) are, at least initially, powered by the electrical energy supplied from the commercial power source 22 via the utility meter 38. As described above, each of the principal motors 20 (PM1 and PM2) include a drive shaft 26 for rotatably driving and operating the respective mechanical apparatuses 12. The recovery motors 24 (RM1 and RM2) have a drive means 28 which is coupled to the drive shaft 26 of the principal motor 20 at a connector 30 (not shown in FIG. 2). Each of the recovery motors 24 (RM1 and RM2) are adapted to recover and generate electric energy directly from the rotational movement of the drive means 28.

The aggregation means 32 then combines the electric energy generated by each of recovery motors 24 (RM1 and RM2) and feeds this electric energy to the inverter means 34. The inverter means 34 receives the aggregated electric energy and converts the energy from direct current to alternating current electric energy or vice versa using any suitable rectifier means. The converted electric energy is then fed from the inverter means 34 to the service panel 36 of the facility 14. A switch means 52 is provided which will enable the recovery system 10 to selectively distribute and feed the recovered electric energy to the commercial power source 22, one or more secondary apparatuses 50 or a combination thereof. The switch means 52 may be automatically or manually actuated into a first position, a second position or a third position. In the first position, the electric energy generated by the recovery system 10 is fed back into commercial power source 22 via the utility meter 38. The switch means 52 may be utilized in this manner if a surplus of electric energy is recovered from the one or more mechanical apparatuses 12 within the facility 14. In the second position, the recovered electric energy is utilized within the facility 14 to operate one or more secondary apparatuses 50, such as illumination devices. It is also contemplated that the recovered electric energy could be fed to the one or more mechanical apparatuses 12 when the switch means 52 is positioned in the second position. When the electric energy generated by the recovery system 10 is insufficient to satisfy the power requirements of the one or more secondary apparatuses 50, the switch means 52 may be actuated into the third position whereby recovered electric energy and the electric energy from the commercial power source 22 are used in combination.

In a further embodiment of the present invention shown in FIG. 2, the switch means 52 comprises a gauge means which is adapted to compare the additional amount of electric energy that is required to operate the one or more mechanical apparatuses 12 once the principal motors 20 have been coupled to the recovery motors 24. In certain applications, such as when a less efficient recovery motor is utilized, the additional electrical energy required to drive both the drive shaft 26 and the drive means 28 may exceed the electric energy recovered by the recovery system 10. In these situations, the gauge means is adapted to deactivated the principal motor 20 and/or the recovery motor 24 until such time as the additional electric energy required to rotatably drive the drive shaft 26 of the principal motor 20 when coupled to the drive means 28 of the recovery motor 24 is less than or equal to the electric energy generated by the recovery motor 24.

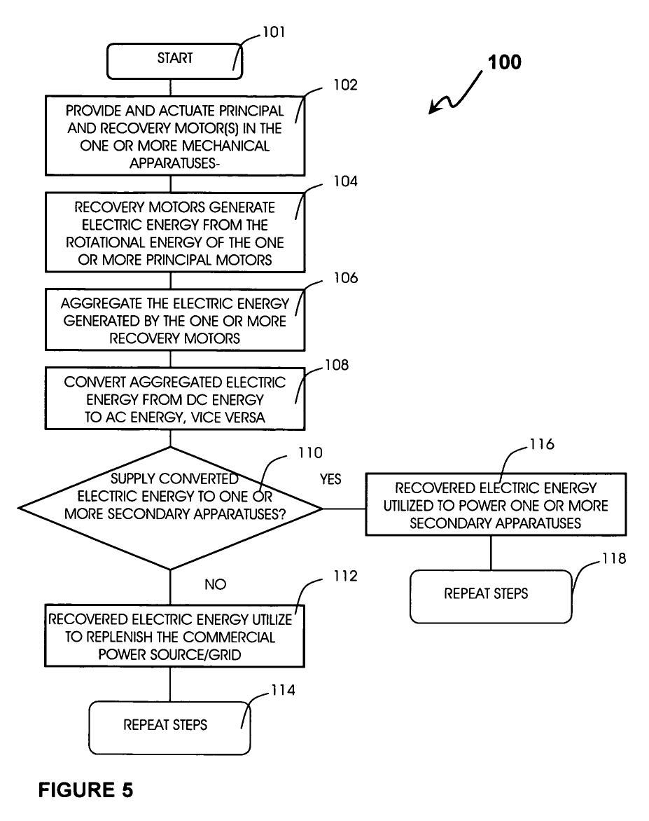

Referring to FIG. 5, the steps in a typical method of recovery electric energy from the operation of one or more mechanical apparatuses in accordance with an embodiment of the present invention are illustrated generally as 100, and starts at step 101. As discussed above, each of the one or more mechanical apparatuses is provided with a principal motor having a drive shaft. At step 102, a recovery motor is provided in association with and, preferably, adjacent to each of the one or more mechanical apparatuses in the residential, commercial and industrial facility. The drive means of the recovery motor is coupled to the drive shaft of the principal motor, such that the rotational movement of the drive means is a function of the rotational movement of the drive shaft when the principal motor is actuated. Following the actuation of the principal motor at step 102, the recovery system 10 at step 104 begins generating electric energy as a result of the rotational movement of the drive means within the recovery motor. At step 106, the electric energy recovered from each of the mechanical apparatuses by recovery motors is aggregated into a signal input of electric energy which is fed to the inverter means at step 108. At step 108, the inverter means converters the aggregated electric energy from direct current electric energy to alternating current electrical energy, or vice versa, in order to enable the energy to be fed into the commercial power source and/or secondary apparatuses.

At step 110, recovery system 10 decides whether the recovered electric energy will be utilized to power any existing secondary apparatuses within the facility or to supplement the electric energy in the commercial power source. Commonly, if the recovery system 10 has generated a surplus of electric energy which is not required for consumption within the subject facility, the surplus will be fed back into the commercial power source 22 at step 112. The method than repeats steps 104 through 110 until such time as the principal motors are deactivated. If the recovered electrical energy is required to operate the secondary apparatuses, and possibly the mechanical apparatuses, the method proceeds to step 116. If the recovered electric energy is not sufficient enough to enable the operation of the secondary apparatuses, the switch means may be actuated to supplement the recovered energy with electric energy from the commercial power source. Again, at step 118, the method repeats steps 104 through 110 until the principals motors are deactivated.

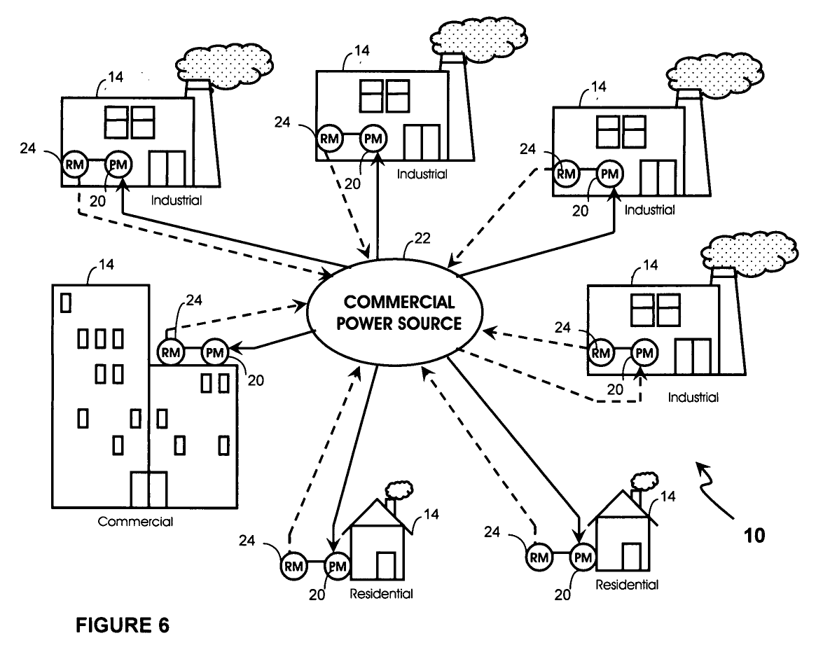

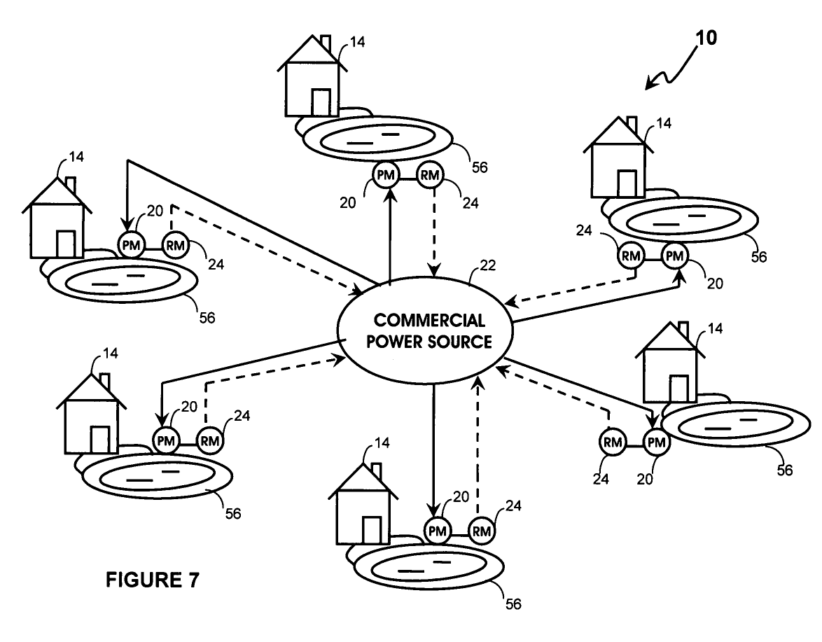

In use, the energy recovery system and method 10, 100 of the present invention may be utilized to recover, generate and supply electric energy to and from mechanical apparatuses in residential, commercial and industrial facilities. Ideally, every facility having air conditioning, ventilation, or similar mechanical apparatuses having principal motors with rotating drive shafts could be utilized in conjunction with the recovery system and method 10, 100 to provide electric energy to the commercial power source. As shown in FIG. 6, the recovering system and method of the present invention would enable participating residential, commercial and industrial facilities to form a network whereby to the energy requirements of one or more facilities is supplemented by the recovered by the recovered electric energy from other facilities via the commercial power source. In the context of a residential facilities in a neighbourhood shown in FIG. 7, the entire neighbourhoods could be generating electric energy from the regular operation of mechanical apparatuses, such as water pumps for outdoor swimming pools 56 (as shown in FIG. 7). It is contemplated the electric energy recovered using the system 10 and method 100 of the present invention may be utilized to power one or more secondary apparatuses, such as, for example, backyard lighting adjacent to the swimming pool. It should be understood that the system and method of the present invention may be utilized with numerous other household mechanical apparatuses, including appliances, washing machines, furnace blowers and air conditions.

In the commercial sector, the present invention may be used in commercial to recover electric energy from the principal motors of large-scale air conditioning and exhaust apparatuses on the rooftops of shopping malls and restaurants. Moreover, in the industrial sector, existing printing presses and other industrial machinery may be retro-fitted to couple the principal motors thereon to an associated recovery motor. By this design, a business in the industrial and manufacturing sectors will be able to reduce energy overhead costs via net metering and possibly generate sufficient electric energy to operate the secondary apparatuses within its facilities. Apart from performing the principals tasks for which they were designed, the utilization of the mechanical apparatuses within these facilities in accordance with the present invention will create numerous sub-generating stations which can be used to supplement the electric energy requirements of third party facilities and the commercial power source.

While what has been shown and described herein constitutes a preferred embodiment of the subject invention, it should be understood that various modifications and adaptions of such embodiment can be made without departing from the present invention.

1. A system for recovering energy from a mechanical apparatus, the system comprising:
(a) a principal motor associated with the mechanical apparatus, the principal motor having a drive shaft for rotatably driving the mechanical apparatus; and
(b) a recovery motor having a drive means coupled to the drive shaft of the principal motor, wherein the rotation of the drive means is a function of the rotation of the drive shaft, and wherein the recovery motor is adapted to generate electric energy from the rotational movement of the drive means.

2. A system as in claim 1, wherein the electric energy generated and recovered by the recovery motor is direct current electric energy.

3. A system as in claim 2, further comprising an inverter means for receiving direct and converting the electric energy from the recovery motor into a useable current using a rectifier means.

4. A system as in claim 1, further comprising a switch means adapted for receiving and providing the alternating current electric energy to commercial power source in a first position and to one or more secondary apparatuses in a second position.

5. A system as in claim 4, wherein the switch means is adapted for receiving and providing the alternating current electric energy to the secondary apparatus and the commercial energy source in a third position.

6. A system as in claim 1, wherein the additional electric energy required to rotatably drive the drive shaft of the principal motor when coupled to the drive means of the recovery motor is less than or equal to the electric energy generated by the recovery motor from the rotational movement of the drive means.

7. A system as in claim 1, further comprising a gauge means for determining when the additional electric energy consumed to rotatably drive the drive shaft of the principal motor exceeds the electric energy generated by the recovery motor from the rotational movement of the drive means.

8. A system as in claim 7, wherein the gauge means is adapted to deactivate the principal motor when the additional electric energy consumed to rotatably drive the drive shaft of the principal motor exceeds the electric energy generated by the recover motor from the rotational movement of the drive means.

9. A system as in claim 1, wherein the recovery motor is a multi-phase, brushless direct current motor.

10. A system as in claim 1, wherein the recovery motor is a single-phase, brushless direct current motor.

11. A system as in claim 1, wherein the horsepower of the recovery motor is less than the horsepower of the principal motor.

12. A method for recovering energy from one or more mechanical apparatuses, each having a principal motor and a drive shaft, the method comprising the steps of:
(a) providing at least one recovery motor having a drive means;
(b) coupling the drive means of the recovery motor to the drive shaft of the principal motor;
(c) actuating the principal motor to rotatably drive the drive shaft and operate the mechanical apparatus, wherein the drive shaft rotatably drives the drive means of the recovery motor, and wherein the rotation of the drive means is a function of the rotation of the drive shaft; and
(d) utilizing the recovery motor to generate electric energy from the rotational movement of the drive means.

13. A method according to claim 12, further comprising the step of providing the electric energy generated at step (d) to a commercial power source.

14. A method according to claim 12, further comprising the step of utilizing the electric energy generated at step (d) to actuate and operate a secondary apparatus.

15. A method according to claim 12, wherein the recovery motor continues to generate electric energy until such time as the principal motor ceases to rotatably drive the drive shaft and operate the mechanical apparatus.

16. A method according to claim 12, wherein step (d) comprises the sub-steps of
(i) generating and recovering electric energy from the rotational movement of the drive means using the recovery motor; and
(ii) converting the recovered electric energy from direct current to alternating current electric energy.

17. A method according to claim 12, wherein step (d) comprises the sub-steps of:
(i) generating and recovering electric energy from the rotational movement of the drive means associated with the at least one recovery motor;
(ii) aggregating the recovered electric energy from the at least one recovery motor;
(ii) converting the recovered electric energy from direct current to alternating current electric energy.

18. A method for recovering energy from one or more facilities having a mechanical apparatus consisting of a principal motor and a drive shaft, the method comprising the steps of:
(a) providing at least one recovery motor having a drive means at each of the one or more facilities;
(b) coupling the drive means of the recovery motor to the drive shaft of the principal motor of the mechanical apparatus;
(c) actuating the principal motor using a commercial power source to rotatably drive the drive shaft and operate the mechanical apparatus, wherein the drive shaft rotatably drives the drive means of the recovery motor, and wherein the rotation of the drive means is a function of the rotation of the drive shaft;
(d) utilizing the recovery motor to generate electric energy from the rotational movement of the drive means resulting from the operation of the mechanical apparatus; and
(e) aggregating and providing the electric energy generated by the recovery motors at each of the one or more facilities to the commercial power source.

19. A method according to claim 18, wherein step (d) comprises the sub-steps of:
(i) utilizing the recovery motor to generate and recover electric energy from the rotational movement of the drive means; and
(ii) converting the recovered electric energy from direct current to alternating current electric energy.
